(19) United States
(12) Patent Application Publication
(10) Pub. No.: US 2010/0028716 A1
(43) Pub. Date: Feb. 4, 2010

(54) NICKEL-BASED BRAZING ALLOY AND METHOD FOR BRAZING

(75) Inventors: Dieter Nuetzel, Hainburg (DE); Thomas Hartmann, Altenstadt (DE)

Correspondence Address: BUCHANAN, INGERSOLL & ROONEY PC, POST OFFICE BOX 1404, ALEXANDRIA, VA, 22313-1404, US

(73) Assignee: Vacuumschmeize GmbH & Co. KG

(21) Appl. No.: 12/309,698

(22) PCT Filed: Aug. 1, 2007
(86) PCT No.: PCT/IB2007/053028

§ 371 Date: Sep. 17, 2009

Related U.S. Application Data
(60) Provisional application No. 60/821,389, filed on Aug. 3, 2006.

(30) Foreign Application Priority Data
Aug. 1, 2006 (DE) 102006036195.4

(51) Int. Cl. B32B 15/01; C22C 19/05; C22C 38/02; C22C 30/00; C22C 30/02; C22C 38/22; C22C 38/20; B23K 1/00; B32B 15/18; C22C 38/42; C21D 8/02; C22F 1/10

(52) U.S. Cl. 428/679; 420/452; 420/453; 420/586.1; 420/582; 420/442; 420/61; 228/256; 228/249; 428/680; 428/681; 428/615; 428/682; 428/685; 420/49; 148/542; 148/555; 148/540

(57) ABSTRACT

Brazing alloy with a composition consisting essentially of FeₐNi_{Rest}Cr_{b}Mo_{c}Cu_{d}SiₑB_{f}P_{g}, wherein 0 atomic %<=a<=50 atomic %; 5 atomic %<=b<=18 atomic %; 0.2 atomic %<c<=3 atomic %; 4 atomic %<=e<=15 atomic %; 4 atomic %<=f<=15 atomic %; 0 atomic %<=g<=6 atomic %; rest Ni, and wherein if 0 atomic %<a<=50 atomic %; then 0.5 atomic %<=d<3 atomic % and if a=0, then 0.5 atomic %<=d<=5 atomic %.

### BACKGROUND

1. Field

Disclosed herein is a nickel-based brazing alloy and to a method for brazing two or more components.

2. Description of Related Art

Soldering is a method for joining metal or ceramic components with the aid of a molten filler material identified as solder. Depending on the processing temperature of the solder, a distinction is made between soft soldering and brazing, the processing temperature typically exceeding the liquidus temperature of the solder by 10° C. to 50° C. While soft solders are processed at temperatures below 450° C., brazing alloys are processed at temperatures above 450° C. Brazing alloys are used in application where a high mechanical strength of the joint and/or a high mechanical strength at elevated operating temperatures are/is required.

Components made of stainless steel or of Ni and Co alloys are often joined by means of Ni-based brazing alloys. The corrosion resistance of the joints produced by means of the brazing alloy is a critical criterion in many applications, in particular in stain-less steel heat exchangers and similar products. In order to increase the application temperature range and to improve corrosion resistance, EP 0 108 959, for example, discloses a nickel-based brazing alloy with a chromium content of 17 to 20 atomic %.

This increased chromium content, however, has the disadvantage of increasing the liquidus temperature and thus the processing temperature. This results in undesirable coarse grain formation in the parent material and in a reduction of its mechanical strength, which is likewise undesirable in many applications. In addition, an increased chromium content of the brazing alloy can result in Cr—B and Cr—Si brittle phases in the brazed seam or in the parent material, which adversely affects the mechanical strength of the joint.

To reduce the chromium content and attempt to solve these problems, WO 96/37335, for example, discloses a nickel-based brazing alloy with a molybdenum content up to 5 atomic % and a reduced chromium content between 9.5 and 16.5 atomic %.

From U.S. Pat. No. 5,183,636 an iron-free brazing alloy is known, which comprises components preventing the diffusion of iron from the parent material into the brazing alloy and components which improve corrosion resistance. For this purpose, the iron-free brazing alloy contains copper, molybdenum, niobium and tantalum. This composition is claimed to improve corrosion resistance, as the chromium content is maintained by the addition of niobium and tantalum and the brazed seam remains iron-free.

A disadvantage of these brazing alloys, however, lies in the fact that the corrosion resistance of the brazed joint is inadequate in aggressive media such as acidic media. In addition, the brazing alloy known from U.S. Pat. No. 5,183,636 is very expensive owing to its components in particular tantalum and niobium.

### SUMMARY

An object of the nickel-based brazing alloy disclosed here is improved corrosion resistance, while providing an alloy which is also cost-effective.

As described herein, a brazing alloy of a composition consisting essentially of

FeₐNi_{Rest}Cr_{b}Mo_{c}Cu_{d}SiₑB_{f}P_{g},

wherein 0 atomic %≦a≦50 atomic %; 5 atomic %≦b≦18 atomic %; 0.2 atomic %≦c≦3 atomic %; 4 atomic %≦e≦15 atomic %; 4 atomic %≦f≦15 atomic %; 0 atomic %≦g≦6 atomic %; rest Ni, and
wherein if 0 atomic %≦a≦50 atomic %; then 0.5 atomic %≦d≦3 atomic %, and if a=0, then 0.5 atomic %≦d≦5 atomic % is provided.

Two alternative compositions are, therefore, provided. In the first embodiment, the brazing alloy comprises iron and a copper content in the range 0.5 atomic %≦d≦3 atomic %. In the second embodiment, the brazing alloy is iron free. In this iron free embodiment, a slightly higher copper content may be provided so that the copper content may in the range 0.5 atomic %≦d≦5 atomic %. However, a preferred copper range for the iron-free brazing alloy is 0.5 atomic %≦d≦3 atomic % as in the iron-containing first embodiment.

By the term “consisting essentially of”, it is to be understood that the brazing alloy may contain trace amounts of unavoidable impurities. Typical impurities may be the elements Al, S, Se, Ti and Zr. The total amount of impurities should be less than 2000 ppm, preferably less than 1000 ppm.

The brazing alloy described herein includes both molybdenum and copper in amounts such that the corrosion resistance is improved over compositions including only one of molybdenum and copper. Surprisingly, it was found that this brazing alloy has a good corrosion resistance without any expensive additions of tantalum and niobium.

This good corrosion resistance is furthermore retained even at an iron content up to 50 atomic %. This further reduces raw material costs, since nickel is partially replaced by iron which is cheaper than nickel. These compositions are particularly suitable for applications where the cost of the material is an important factor.

In a further embodiment, the brazing alloy preferably combines an addition of 0.2 to 1.5 atomic % of molybdenum with an addition of 0.5 to 3 atomic % of copper to improve corrosion resistance.

The brazing alloy described herein has been found suitable for application in highly aggressive media, such as heat exchangers for internal combustion engines and exhaust gas recirculation coolers. In these applications, the brazed joint is exposed to reductive or oxidising acidic media, which may further include sulphate and/or nitrate and/or chloride ions. Brazed seams produced using the brazing alloy described herein also exhibit a good corrosion resistance in these aggressive media. Further applications for the brazing alloy according to the invention include the joining of two or more components of industrial-type stainless steel heat exchangers and of heat exchangers in cars and commercial vehicles, where aggressive media are generated.

### BRIEF DESCRIPTION OF THE DRAWINGS

FIG. 1 is a graph that illustrates the weight loss in a corrosion test on stainless steel samples with brazed joints of a first basic composition with additions of Mo and/or Cu;

FIG. 2 is a graph that illustrates the weight loss in a corrosion test on stainless steel samples with brazed joints of a second basic composition with various Mo additions;

FIG. 3 is a graph that illustrates the weight loss in a corrosion test on stainless steel samples with brazed joints of a second basic composition with various Cu additions; and

FIG. 4 is a graph that illustrates the weight loss in a corrosion test on stainless steel samples with brazed joints of a second basic composition with varying iron content.

### DETAILED DESCRIPTION OF SPECIFIC EMBODIMENTS

The good corrosion resistance of the brazing solder disclosed herein is achieved with a moderate chromium content of 5 to 18 atomic %, whereby the disadvantages of high-chromium alloys are avoided. In contrast to a composition with an increased chromium content, the combined addition of Mo and Cu does not result in an undesirable increase in liquidus temperature and thus in the processing temperature of the brazing alloy. The moderate chromium content described herein ensures that the strong formation of Cr—B and Cr—Si brittle phases is avoided both in the brazed seam and in the parent material. A good corrosion resistance is provided by the addition of Mo and Cu in spite of the low chromium content.

The brazing alloy described herein has a liquidus temperature of less than 1200° C. This is desirable, because the maximum brazing temperature for many industrial processes, in particular for joining stainless steel parent materials, is limited to approximately 1200° C. As a rule, brazing temperature is kept as low as possible because of undesirable coarse grain formation in the parent material at temperatures from 1000° C. This undesirable coarse grain formation results in a reduction of the mechanical strength of the parent material, which is critical for many technological applications such as heat exchangers. This problem is significantly reduced by the brazing alloy according described herein.

The brazing alloy is therefore reliable in industrial applications with a maximum soldering temperature limited to 1200° C. It provides for a reliable brazed joint.

In further embodiments, the brazing solder has an Si content of 7≦e≦12 atomic % and/or a B content of 5≦f≦13 atomic % and/or a Cr content of 5≦b≦14 atomic %.

The elements boron, silicon and phosphorus are metalloid and glass-forming elements and permit the production of the brazing alloy as an amorphous, ductile foil. A higher content of these elements leads to a reduction of melting or liquidus temperature. If the content of glass-forming elements is too low, the foils solidify in a crystalline manner and become very brittle. If, on the other hand, the content of glass-forming elements is too high, the foils become brittle and can no longer be processed for technological applications.

The metalloid content is further chosen such that the brazed seam produced using a foil of brazing alloy has suitable mechanical properties. A high B content results in the separation of B hard phases, leading to a deterioration of the mechanical properties of the brazed joint. Boron reacts with chromium, likewise resulting in a noticeable reduction of corrosion resistance. A high Si content results in the formation of undesirable Si hard phases in the brazed seam, which likewise reduces the strength of the soldered seam.

The brazing alloy according to any of the embodiments described above can be provided as a paste or as an amorphous, ductile brazing alloy foil. The brazing alloy according to the invention can be produced as a powder or as an amorphous, ductile foil, for example in a rapid solidification process. These brazing alloys are therefore available in various forms which can be adapted to different applications.

In one embodiment, the brazing alloy foil is up to 50%, preferably at least up to 80%, amorphous.

The brazing alloy foils according to the invention can be produced as ductile foils in increased strip thicknesses and increased strip widths. The brazing alloys according to the invention are therefore excellently suitable for casting with thicknesses of more than 20 μm, preferably of 20 μm≦D≦40 μm, and with widths of more than 20 mm, preferably 20 mm≦B≦200 mm, which is possible only to a very limited degree with nickel-based brazing alloys of prior art.

In one embodiment, a heat exchanger is provided with at least one brazed seam produced with a brazing alloy of a composition consisting essentially of

FeₐNi_{Rest}Cr_{b}Mo_{c}Cu_{d}SiₑB_{f}P_{g},

wherein 0 atomic %≦a≦50 atomic %; 5 atomic %≦b≦18 atomic %; 0.2 atomic %≦c≦3 atomic %; 4 atomic %≦e≦15 atomic %; 4 atomic %≦f≦15 atomic %; 0 atomic %≦g≦6 atomic %; rest Ni, and
wherein if 0 atomic %<a≦50 atomic %; then 0.5 atomic %≦d≦3 atomic %, and if a=0, then 0.5 atomic %≦d≦5 atomic %.

In another embodiment, this brazed seam is produced using a brazing alloy of this composition in the form of an amorphous, ductile brazing alloy foil. The heat exchanger may have at least one brazed seam produced with a brazing alloy or an amorphous, ductile brazing alloy foil according to any of the embodiments described above. The brazed seam produced with an amorphous, ductile brazing alloy foil has a thickness of at least 20 μm.

The brazed seam produced with an amorphous, ductile brazing alloy foil differs from a brazed seam produced by means of a crystalline powder in the size of the B and Si hard phases.

A method for joining two or more components, which comprises the following steps, is provided. A brazing alloy according to any of the embodiments described above is applied between two or more of the metal components to be joined. The components to be joined have a higher melting temperature than the brazing alloy and may be made of stainless steel or an Ni or Co alloy. The brazing composite is heated to a temperature above the liquidus temperature of the brazing alloy and then cooled while a brazed joint forms between the components to be joined. The method may join the components by adhesive force or cohesively.

A further method for joining two or more components, which comprises the following steps, is provided. An amorphous, ductile brazing alloy foil according to any of the embodiments described above is applied between two or more of the metal components to be joined. The components to be joined have a higher melting temperature than the brazing alloy foil and may be made of stainless steel or an Ni or Co alloy. The brazing composite is heated to a temperature above the liquidus temperature of the brazing alloy foil and then cooled while a brazed joint forms between the components to be joined.

The components to be joined are preferably components of a heat exchanger or exhaust gas recirculation cooler or components of a fuel cell. These products require a reliable brazed joint which is completely leak-proof, resistant against corrosion at elevated operating temperatures, mechanically stable and therefore reliable. The brazing alloy foils according to the invention provide such a joint.

The brazing alloys and brazing alloy foils described herein can be used to produce one or more brazed seams in an object. The brazed object may be a heat exchanger, an exhaust gas recirculation cooler or a component of a fuel cell. In one embodiment, the brazed object is designed for use in a reductive or oxidising acidic medium, in another embodiment for use in a reductive medium and in yet another embodiment for use in an oxidising acidic medium which further contains sulphate and/or nitrate and/or chloride ions, or for use in a reductive or oxidising acidic medium of an internal combustion engine.

The brazing alloys described herein are produced as amorphous, homogeneous and ductile brazing alloy foils in a rapid solidification process in one embodiment of the method. For this purpose, a metal melt with the composition FeₐNi_{Rest}Cr_{b}Mo_{c}Cu_{d}SiₑB_{f}P_{g} is provided, consisting essentially of

FeₐNi_{Rest}Cr_{b}Mo_{c}Cu_{d}SiₑB_{f}P_{g},

wherein 0 atomic %≦a≦50 atomic %; 5 atomic %≦b≦18 atomic %; 0.2 atomic %≦c≦3 atomic %; 4 atomic %≦e≦15 atomic %; 4 atomic %≦f≦15 atomic %; 0 atomic %≦g≦6 atomic %; rest Ni, and
wherein if 0 atomic %≦a≦50 atomic %; then 0.5 atomic %≦d≦3 atomic %, and if a=0, then 0.5 atomic %≦d≦5 atomic %.

This melt is sprayed through a casting nozzle onto a casting wheel or casting drum and cooled at a rate of more than 10⁵° C./s. The cast strip is then typically removed from the casting wheel at a temperature between 100° C. and 300° C. and directly wound to form a so-called coil or wound onto a reel to provide an amorphous, ductile brazing alloy foil.

In a further method, amorphous brazing alloy foils are used to join two or more components by adhesive force, the method comprising the following steps:
Provision of a melt of FeₐNi_{Rest}Cr_{b}Mo_{c}Cu_{d}SiₑB_{f}P_{g}, consisting essentially of

FeₐNi_{Rest}Cr_{b}Mo_{c}Cu_{d}SiₑB_{f}P_{g},
wherein 0 atomic %≦a≦50 atomic %; 5 atomic %≦b≦18 atomic %; 0.2 atomic %<c≦3 atomic %; 4 atomic %≦e≦15 atomic %; 4 atomic %≦f≦15 atomic %; 0 atomic %≦g≦6 atomic %; rest Ni, and
wherein if 0 atomic %<a≦50 atomic %; then 0.5 atomic %≦d≦3 atomic %, and if a=0, then 0.5 atomic %≦d≦5 atomic %.
Production of an amorphous brazing alloy foil by rapid solidification of the melt on a moving cooling surface at a rate of more than approximately 10⁵° C./s;
Formation of a brazing composite by applying the brazing alloy foil between the metal components to be joined;
Heating of the brazing composite to a temperature above the liquidus temperature of the brazing alloy foil;
Cooling of the brazing composite accompanied by the formation of a joint between the metal components to be joined.

The process of joining by adhesive force as described above involves brazing with the nickel brazing alloy described herein, which is capable of producing perfect brazed joints without any joining faults.

The liquidus temperature of the brazing alloy described herein is less than 1200° C. The brazing alloy described herein can in particular be used to join metal components made of stainless steel and/or nickel and/or Co alloys by adhesive force. Such components typically include components used in heat exchangers or related products and in exhaust gas recirculation coolers.

The various embodiments described herein are disclosed in more detail below with reference to specific nonlimiting embodiments and comparative examples.

At least partially amorphous nickel- and iron-based brazing alloy foils of various compositions were produced in a rapid solidification process. The corrosion resistance of brazed seams with additions of Cu, Mo or a combination of Cu and Mo was compared to that of brazing alloy foils without molybdenum and copper.

In a first embodiment, the corrosion resistance of a combination of Mo and Cu additions was compared to that of Mo only and Cu only in a first basic composition. At least partially amorphous brazing alloy foils were produced by means of rapid solidification technology. The compositions of the foil are listed in Table 1.

In this first embodiment, the brazing alloy foils had a composition of 12.3 atomic % Cr, 3.7 atomic % Fe, 7.9 atomic % Si and 12.8 atomic % B, the rest being nickel. Further foils were produced with 12.3 atomic % Cr, 3.7 atomic % Fe, 7.9 atomic % Si and 12.8 atomic % B with additions of copper and/or molybdenum, the rest being nickel. One brazing alloy foil contains 2 atomic % of copper, a second foil 1 atomic % of molybdenum and a third foil 1 atomic % of molybdenum and 2 atomic % of copper.

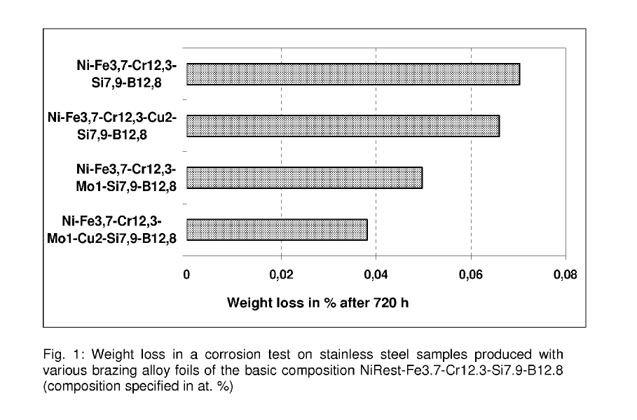

Stainless steel samples (316L, 1.4404), wherein a base plate is joined to two tube sections, were brazed in a vacuum using the above foils at a temperature of 1200° C. The brazed components were placed in a corrosive medium with pH<2 and SO₄²⁻, NO₃⁻ and Cl⁻ ions at 70° C. The weight loss of the various samples after 720 hours of exposure is shown in FIG. 1.

FIG. 1 shows clearly that an addition of Cu only or of Mo only results in an only moderate improvement of corrosion resistance compared to a brazed joint produced without Mo and Cu. The lowest weight loss and therefore the best corrosion resistance is found in the brazing alloy containing both Mo and Cu. The combined addition of Mo and Cu provides a brazing alloy with improved corrosion resistance compared to a brazing alloy containing neither Mo nor Cu.

In a second embodiment, the influence of a combined addition of Mo and Cu on the corrosion resistance of a second basic composition was investigated. In this second embodiment, a brazing alloy with a combination of Mo and Cu additions was compared to copper-free brazing alloys with increasing Mo content.

At least partially amorphous brazing alloy foils were produced by means of rapid solidification technology. In this second embodiment, the brazing alloy foils had a basic composition of 11 atomic % Cr, 35 atomic % Ni, 11.5 atomic % Si and 7 atomic % B, the rest being iron. Copper-free foils were produced with 11 atomic % Cr, 35 atomic % Ni, 11.5 atomic % Si and 7 atomic % B with 0.5, 1 and 1.5 atomic % molybdenum, the rest being iron. In addition, a foil was produced with 11 atomic % Cr, 35 atomic % Ni, 11.5 atomic % Si and 7 atomic % B with an addition of 2 atomic % copper and 1 atomic % Mo, the rest being iron. These compositions are listed in Table 2. The second basic composition therefore contains significantly more iron than the first basic composition.

Stainless steel samples were produced as in the first embodiment, and corrosion resistance was tested as described above. In the second embodiment, the samples were exposed for 864 hours, whereupon their weight loss was measured.

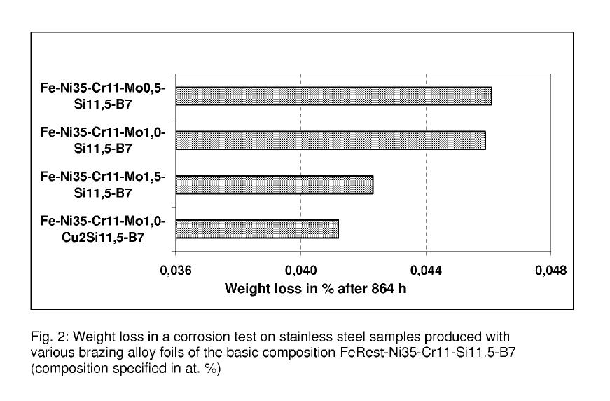

As FIG. 2 shows, the alloy with a combined addition of Mo and Cu loses the least weight and has therefore the best corrosion resistance. The corrosion resistance of the alloy containing both Mo and Cu cannot be reached by simply varying the molybdenum content in an alloy comprising only molybdenum and no copper.

In a third embodiment, the influence of a combined addition of Mo and Cu on the corrosion resistance of a third basic composition was investigated. At least partially amorphous brazing alloy foils were produced by means of rapid solidification technology. In this third embodiment, the brazing alloy foils had a basic composition of 11 atomic % Cr, 35 atomic % Ni, 11.5 atomic % Si and 7 atomic % B, the rest being iron. A copper-free foil was produced with 11 atomic % Cr, 35 atomic % Ni, 11.5 atomic % Si and 7 atomic % B with 1 atomic % molybdenum, the rest being iron. Molybdenum-free foils were produced with 11 atomic % Cr, 35 atomic % Ni, 11.5 atomic % Si and 7 atomic % B with an addition of 1 and 2 atomic % copper, each with 1 atomic % Mo, the rest being iron. These compositions are listed in Table 3.

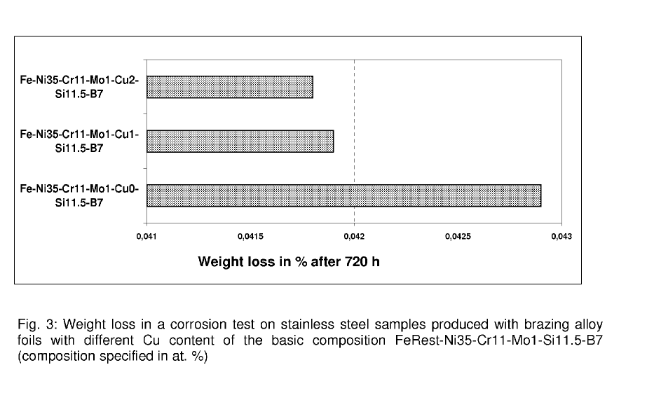

Stainless steel samples were produced as in the first embodiment, and corrosion resistance was tested as described above. FIG. 3 shows their weight loss after 720 hours' exposure.

FIG. 3 shows that the corrosion resistance of brazing alloys with additions of Mo and Cu is noticeably better than that of alloys with Mo only.

In a fourth embodiment, the corrosion resistance of at least partially amorphous brazing alloy foils with a combination of 1 atomic % Mo and 1 atomic % Cu and increasing iron content was investigated.

The at least partially amorphous brazing alloy foils were produced by means of rapid solidification technology. At least partially amorphous foils with an Fe content of 0, 10, 20, 30, 40, 50, 60 and 70 atomic %, each with a Cr content of 11 atomic %, an Si content of 9 atomic %, a B content of 9 atomic %, an Mo content of 1 atomic % and a Cu content of 2 atomic %, were produced, the rest being nickel. These compositions are listed in Table 4.

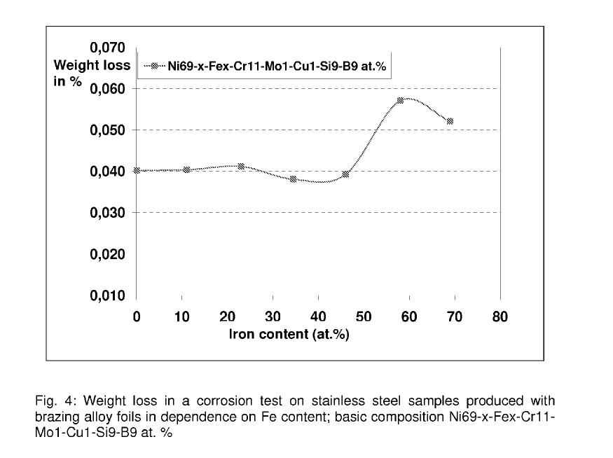

FIG. 4 shows that the corrosion resistance of foils containing Mo and Cu remains virtually constant up to an Fe content of 50 atomic %. This offers the advantage that nickel can be replaced by iron up to an Fe content of 50 atomic % without significantly affecting corrosion resistance. As a result, raw material costs can be reduced.

TABLE 1
Composition of the brazing alloy foils of the first embodiment

| | Ni | Fe | Cr | Mo | Cu | Si | B |
|---|---|---|---|---|---|---|---|
| No. | (at. %) | (at. %) | (at. %) | (at. %) | (at. %) | (at. %) | (at. %) |
| 1* | Rest | 3.7 | 12.3 | 0 | 0 | 7.9 | 12.8 |
| 2* | Rest | 3.7 | 12.3 | 0 | 2 | 7.9 | 12.8 |
| 3* | Rest | 3.7 | 12.3 | 1 | 0 | 7.9 | 12.8 |
| 4 | Rest | 3.7 | 12.3 | 1 | 2 | 7.9 | 12.8 |

*comparative examples

TABLE 2
Composition of the brazing alloy foils of the second embodiment

| | Ni | Fe | Cr | Mo | Cu | Si | B |
|---|---|---|---|---|---|---|---|
| No. | (at. %) | (at. %) | (at. %) | (at. %) | (at. %) | (at. %) | (at. %) |
| 5* | 35 | Rest | 11 | 0.5 | 0 | 11.5 | 7 |
| 6* | 35 | Rest | 11 | 1 | 0 | 11.5 | 7 |
| 7* | 35 | Rest | 11 | 1.5 | 0 | 11.5 | 7 |
| 8 | 35 | Rest | 11 | 1 | 2 | 11.5 | 7 |

*comparative examples

TABLE 3
Composition of the brazing alloy foils of the third embodiment

| | Ni | Fe | Cr | Mo | Cu | Si | B |
|---|---|---|---|---|---|---|---|
| No. | (at. %) | (at. %) | (at. %) | (at. %) | (at. %) | (at. %) | (at. %) |
| 9* | 35 | Rest | 11 | 1 | 0 | 11.5 | 7 |
| 10 | 35 | Rest | 11 | 1 | 1 | 11.5 | 7 |
| 11 | 35 | Rest | 11 | 1 | 2 | 11.5 | 7 |

*comparative examples

TABLE 4
Composition of the brazing alloy foils of the fourth embodiment

| Ni | Fe | Cr | Mo | Cu | Si | B |
|---|---|---|---|---|---|---|
| (at. %) | (at. %) | (at. %) | (at. %) | (at. %) | (at. %) | (at. %) |
| 69 | 0 | 11 | 1 | 1 | 9 | 9 |
| 59 | 10 | 11 | 1 | 1 | 9 | 9 |
| 49 | 20 | 11 | 1 | 1 | 9 | 9 |
| 39 | 30 | 11 | 1 | 1 | 9 | 9 |
| 29 | 40 | 11 | 1 | 1 | 9 | 9 |
| 19 | 50 | 11 | 1 | 1 | 9 | 9 |
| 9 | 60 | 11 | 1 | 1 | 9 | 9 |
| 0 | 69 | 11 | 1 | 1 | 9 | 9 |

The invention has been described with reference to certain specific embodiments and examples, which are intended to illustrate the invention without limiting the scope of the appended claims.

1. A brazing alloy having a composition consisting essentially of
FeₐNi_{Rest}Cr_{b}Mo_{c}Cu_{d}SiₑB_{f}P_{g},
wherein 0 atomic %≦a≦50 atomic %; 5 atomic %≦b≦18 atomic %; 0.2 atomic %<c≦3 atomic %; 4 atomic %≦e≦15 atomic %; 4 atomic %≦f≦15 atomic %; 0 atomic %≦g≦6 atomic %; rest Ni, and
wherein if 0 atomic %<a≦50 atomic %; then 0.5 atomic %≦d<3 atomic %, and if a=0, then 0.5 atomic %≦d≦5 atomic %.

2. The brazing alloy according to claim 1, wherein if a=0, then 0.5 atomic %≦d<3 atomic %.

3. The brazing alloy according to claim 1, wherein the alloy has
a Si content such that 7 atomic %≦e≦12 atomic %.

4. The brazing alloy according to claim 1 wherein the alloy has,
a Cr content such that 5 atomic %≦b≦14 atomic %.

5. The brazing alloy according to claim 1 wherein the alloy has,
a B content such that 5 atomic %≦f≦13 atomic %.

6. The brazing alloy according to claim 1 wherein the alloy has,
an Fe content such that 3 atomic %≦a≦35 atomic %.

7. The brazing alloy according to claim 1 wherein the alloy has,
a liquidus temperature of less than 1200° C.

8. An amorphous, ductile brazing alloy foil comprising the brazing alloy of claim 1.

9. The amorphous, ductile brazing alloy foil according to claim 8 wherein,
if a=0, then 0.5 atomic %≦d<3 atomic %.

10. The amorphous, ductile brazing alloy foil according to claim 8 wherein the alloy has
a Si content such that 7 atomic %≦e≦12 atomic %.

11. The amorphous, ductile brazing alloy foil according to claim 8, wherein the alloy has
a Cr content such that 5 atomic %≦b≦14 atomic %.

12. The amorphous, ductile brazing alloy foil according to claim 8, wherein the alloy has
a B content such that 5≦f≦13 atomic %.

13. The amorphous, ductile brazing alloy foil according to claim 8, wherein the alloy has
an Fe content such that 3 atomic %≦a≦35 atomic %.

14. The amorphous, ductile brazing alloy foil according to claim 47, wherein
the brazing alloy foil is at least 80% amorphous.

15. The amorphous, ductile brazing alloy foil according to claim 8,
having
a thickness D of more than 20 μm.

16. The amorphous, ductile brazing alloy foil according to claim 15 wherein the,
thickness D is such that 20 μm≦D≦40 μm.

17. The amorphous, ductile brazing alloy foil according to claim 8 having,
a width B of 20 mm≦B≦200 mm.

18. The amorphous, ductile brazing alloy foil according to claim 17 wherein the,
width B of is such that 40 mm≦B≦200 mm.

19-20. (canceled)

21. A method for joining two or more components, comprising:
applying a brazing alloy according to claim 1 between two or more components, wherein the components have a higher melting temperature than the melting temperature of the brazing alloy to form a brazing composite;
heating the brazing composite to a temperature above the liquidus temperature of the brazing alloy; and
cooling the brazing composite, thereby forming a brazed joint between the components to be joined.

22. The method according to claim 21 wherein,
the components comprise components of a heat exchanger or an exhaust gas recirculation cooler or a fuel cell.

23. A method for joining two or more components, comprising:
applying an amorphous, ductile brazing alloy foil according to claim 8 between the two or more components, wherein the components having a higher melting temperature than the melting temperature of the brazing alloy foil to form a brazing composite;
heating the brazing composite to a temperature above the liquidus temperature of the brazing alloy foil; and
cooling the brazing composite, thereby forming a brazed joint between the components.

24. The method according to claim 23, wherein the components compromise components of a heat exchanger or an exhaust gas recirculation cooler or a fuel cell.

25. A method for joining two or more components, comprising:
providing a melt consisting essentially of
FeₐNi_{Rest}Cr_{b}Mo_{c}Cu_{d}SiₑB_{f}P_{g},
wherein 0 atomic %≦a≦50 atomic %; 5 atomic %≦b≦18 atomic %; 0.2 atomic %<c≦3 atomic %; 4 atomic %≦e≦15 atomic %; 4 atomic %≦f≦15 atomic %; 0 atomic %≦g≦6 atomic %; rest Ni, and
wherein if 0 atomic %<a≦50 atomic %; then 0.5 atomic %≦d<3 atomic %, and if a=0, then 0.5 atomic %≦d≦5 atomic %,
producing an amorphous brazing alloy foil by rapid solidification of the melt on a moving cooling surface at a rate of more than approximately 10⁵° C./s;
forming a brazing composite by applying the brazing alloy foil between the components;
heating the brazing composite to a temperature above the liquidus temperature of the brazing alloy foil; and
cooling the brazing composite therey forming a brazed joint between the components.

26. A method for the production of an amorphous, ductile brazing alloy foil, comprising:
providing of a melt consisting essentially of
FeₐNi_{Rest}Cr_{b}Mo_{c}Cu_{d}SiₑB_{f}P_{g},
wherein 0 atomic %≦a≦50 atomic %; 5 atomic %≦b≦18 atomic %; 0.2 atomic %<c≦3 atomic %; 4 atomic %≦e≦15 atomic %; 4 atomic %≦f≦15 atomic %; 0 atomic %≦g≦6 atomic %; rest Ni, and
wherein if 0 atomic %<a≦50 atomic %; then 0.5 atomic %≦d<3 atomic %, and if a=0, then 0.5 atomic %≦d≦5 atomic %,
producing of an amorphous brazing alloy foil by rapid solidification of the melt on a moving cooling surface at a rate of more than approximately 10⁵° C./s.

27. (canceled)

28. A brazed object, comprising two or more components joined by
at least one brazed seam produced from a brazing alloy according to claim 1.

29. The brazed object according to claim 28, wherein the brazed object is a heat exchanger, an exhaust gas recirculation cooler or a component of a fuel cell.

30. The brazed object according to claim 28, wherein the brazed object is to be exposed to a reductive or oxidising acidic medium.

31. The brazed object according to claim 30, wherein the reductive or oxidising acidic medium contains sulphate or nitrate or chloride ions or mixture of these.

32. The brazed object according to claim 28, wherein the reductive or oxidising acidic medium is that of an internal combustion engine.

33. The brazed object according to claim 28, wherein the two or more components are made of stainless steel or an Ni alloy or a Co alloy and are joined by adhesive force.

34-35. (canceled)

36. A brazed object, comprising two or more components joined by
at least one brazed seam produced from an amorphous, ductile brazing alloy foil according to claim 8.

37-42. (canceled)

43. The brazed object according to claim 28, wherein the brazed object is a heat exchanger and wherein the brazed seam is >20 μm in thickness.

44. The brazing alloy according to claim 1, wherein the amount of Mo is such that 0.2≦c≦1.5 atomic %.

45. The brazing alloy according to claim 1, wherein the amount of Cu is such that 0.5≦d≦3% atomic %.

46. The brazing alloy according to claim 1, which is in the form of a powder.

47. The amorphous, ductile brazing alloy foil according to claim 8, wherein the brazing foil is at least 50% amorphous.
